(19) United States
(12) Patent Application Publication
(10) Pub. No.: US 2016/0075832 A1
(43) Pub. Date: Mar. 17, 2016

(54) Process for Preventing Thiophenol Formation and/or Accumulation During Production of Poly(Arylene Sulfide)

(71) Applicant: SOLVAY SA, Brussels (BE)

(72) Inventors: David A. Soules, Bartlesville, OK (US); Justin W. Kamplain, Bartlesville, OK (US); R. Shawn Childress, Bartlesville, OK (US); Jeffrey S. Fodor, Bartlesville, OK (US)

(21) Appl. No.: 14/483,326

(22) Filed: Sep. 11, 2014

(51) Int. Cl. C08G 75/14

(52) U.S. Cl. CPC C08G 75/14

(57) ABSTRACT

A process for producing a poly(arylene sulfide) polymer comprising (a) polymerizing reactants in a reaction vessel to produce a poly(arylene sulfide) reaction mixture, (b) processing at least a portion of the poly(arylene sulfide) reaction mixture to obtain a poly(arylene sulfide) reaction mixture downstream product, and (c) contacting a reactive aryl halide with at least a portion of the poly(arylene sulfide) reaction mixture and/or downstream product thereof, wherein before and/or after the contacting, the poly(arylene sulfide) reaction mixture and/or downstream product thereof comprise less than about 0.025 wt. % thiophenol, based on the total weight of the poly(arylene sulfide) reaction mixture and/or downstream product thereof.

### TECHNICAL FIELD

The present disclosure relates to a process of producing polymers, more specifically poly(arylene sulfide) polymers.

### BACKGROUND

Polymers, such as poly(arylene sulfide) polymers and their derivatives, are used for the production of a wide variety of articles. Generally, the process for producing a particular polymer and any steps thereof can drive the cost of such particular polymer, and consequently influences the economics of polymer articles. Thus, there is an ongoing need to develop and/or improve processes for producing these polymers.

### BRIEF SUMMARY

Disclosed herein is a process for producing a poly(arylene sulfide) polymer comprising (a) polymerizing reactants in a reaction vessel to produce a poly(arylene sulfide) reaction mixture, (b) processing at least a portion of the poly(arylene sulfide) reaction mixture to obtain a poly(arylene sulfide) reaction mixture downstream product, and (c) contacting a reactive aryl halide with at least a portion of the poly(arylene sulfide) reaction mixture and/or downstream product thereof, wherein before and/or after the contacting, the poly(arylene sulfide) reaction mixture and/or downstream product thereof comprise less than about 0.025 wt. % thiophenol, based on the total weight of the poly(arylene sulfide) reaction mixture and/or downstream product thereof.

Also disclosed herein is a process for producing a poly(phenylene sulfide) polymer comprising (a) polymerizing reactants in a reaction vessel to produce a poly(phenylene sulfide) reaction mixture, (b) processing at least a portion of the poly(phenylene sulfide) reaction mixture to obtain a poly(phenylene sulfide) reaction mixture downstream product, and (c) contacting a reactive aryl halide with at least a portion of the poly(phenylene sulfide) reaction mixture and/or downstream product thereof, wherein before and/or after the contacting, the poly(phenylene sulfide) reaction mixture and/or downstream product thereof comprise less than about 0.025 wt. % thiophenol, based on the total weight of the poly(phenylene sulfide) reaction mixture and/or downstream product thereof.

Further disclosed herein is a process for producing a poly(arylene sulfide) polymer comprising (a) polymerizing reactants in a reaction vessel to produce a poly(arylene sulfide) reaction mixture, (b) removing at least a portion of the reaction mixture from the reaction vessel to yield a removed portion, (c) washing the removed portion of the poly(arylene sulfide) reaction mixture with a polar organic compound and/or water to obtain a poly(arylene sulfide) polymer and a first slurry, and (d) contacting a reactive aryl halide with at least a portion of the first slurry, wherein before and/or after the contacting, the first slurry comprises less than about 0.025 wt. % thiophenol, based on the total weight of the first slurry.

Further disclosed herein is a process for producing a poly(phenylene sulfide) polymer comprising (a) reacting a sulfur source and a dihaloaromatic compound in the presence of N-methyl-2-pyrrolidone to form a poly(phenylene sulfide) reaction mixture, (b) removing at least a portion of the poly(phenylene sulfide) reaction mixture from the reaction vessel to yield a removed portion, (c) washing the removed portion of the poly(phenylene sulfide) reaction mixture with N-methyl-2-pyrrolidone and/or water to obtain a poly(phenylene sulfide) polymer and a first slurry, and (d) contacting a reactive aryl halide with at least a portion of the first slurry, wherein before and/or after the contacting, the first slurry comprises less than about 0.025 wt. % thiophenol, based on the total weight of the first slurry.

Further disclosed herein is a process for producing a poly(arylene sulfide) polymer comprising (a) polymerizing reactants in a reaction vessel to produce a poly(arylene sulfide) reaction mixture, (b) cooling the poly(arylene sulfide) reaction mixture in the reaction vessel to a temperature of less than about 200° C., and (c) contacting a reactive aryl halide with the poly(arylene sulfide) reaction mixture in the reaction vessel, wherein before and/or after the contacting, the poly(arylene sulfide) reaction mixture comprises less than about 0.025 wt. % thiophenol, based on the total weight of the poly(arylene sulfide) reaction mixture.

Further disclosed herein is a process for producing a poly(phenylene sulfide) polymer comprising (a) polymerizing reactants in a reaction vessel to produce a poly(phenylene sulfide) reaction mixture, (b) cooling the poly(phenylene sulfide) reaction mixture in the reaction vessel to a temperature of less than about 200° C. to yield a cooled poly(phenylene sulfide) reaction mixture, and (c) contacting a reactive aryl halide with the cooled poly(phenylene sulfide) reaction mixture in the reaction vessel, wherein before and/or after the contacting, the poly(phenylene sulfide) reaction mixture comprises less than about 0.025 wt. % thiophenol, based on the total weight of the poly(phenylene sulfide) reaction mixture.

Further disclosed herein is a process for producing a poly(arylene sulfide) polymer comprising (a) polymerizing reactants in a reaction vessel to produce a poly(arylene sulfide) reaction mixture, (b) removing at least a portion of the reaction mixture from the reaction vessel to yield a removed portion of the reaction mixture, (c) processing at least a portion of the removed portion of the reaction mixture to obtain a downstream processed product, and (d) contacting a reactive aryl halide with at least a portion of the (i) poly(arylene sulfide) reaction mixture, (ii) removed portion of the reaction mixture, and/or (iii) downstream processed product, wherein before and/or after the contacting, the (i) poly(arylene sulfide) reaction mixture, (ii) removed portion of the reaction mixture, and/or (iii) downstream processed product comprise less than about 0.025 wt. % thiophenol, based on the total weight of the downstream processed product.

Further disclosed herein is a process for producing a poly(arylene sulfide) polymer comprising (a) polymerizing reactants in a reaction vessel to produce a poly(arylene sulfide) reaction mixture, (b) removing at least a portion of the reaction mixture from the reaction vessel to yield a removed portion of the reaction mixture, (c) processing at least a portion of the removed portion of the reaction mixture to obtain a solid poly(arylene sulfide) polymer and a liquid product, and (d) contacting a reactive aryl halide with at least a portion of the (i) poly(arylene sulfide) reaction mixture, (ii) removed portion of the reaction mixture, and/or (iii) liquid product, wherein before and/or after the contacting, the (i) poly(arylene sulfide) reaction mixture, (ii) removed portion of the reaction mixture, and/or (iii) liquid product comprise less than about 0.025 wt. % thiophenol, based on the total weight of the liquid product.

### BRIEF DESCRIPTION OF THE DRAWINGS

For a detailed description of the preferred embodiments of the disclosed processes, reference will now be made to the accompanying drawings in which:

FIG. 1 displays a graph of thiophenol formation at 265° C. in different samples in the presence and in the absence of a reactive aryl halide;

FIG. 2 displays a graph of thiophenol formation at 282° C. in different samples in the presence and in the absence of a reactive aryl halide;

FIG. 3 displays a graph of 1,2,4-trichlorobenzene (1,2,4-TCB) consumption at various time points;

FIG. 4 displays a graph of amounts of reactive aryl halides distilled with water and/or N-methyl-2-pyrrolidone (NMP); and

FIG. 5 displays a graph of 1270ER response for a 4,4′-dichlorodiphenyl sulfone (DCDPS) addition.

### DETAILED DESCRIPTION

Disclosed herein are processes for producing poly(arylene sulfide) polymers. The present application relates to poly(arylene sulfide) polymers, also referred to herein simply as “poly(arylene sulfide).” In the various embodiments disclosed herein, it is to be expressly understood that reference to poly(arylene sulfide) polymer specifically includes, without limitation, polyphenylene sulfide polymer (or simply, polyphenylene sulfide), also referred to as PPS polymer (or simply, PPS).

In an embodiment, a process for producing a poly(arylene sulfide) polymer can comprise the steps of (a) polymerizing reactants in a reaction vessel to produce a poly(arylene sulfide) reaction mixture; (b) processing at least a portion of the poly(arylene sulfide) reaction mixture to obtain a poly(arylene sulfide) reaction mixture downstream product; and (c) contacting a reactive aryl halide with at least a portion of the poly(arylene sulfide) reaction mixture and/or downstream product thereof, wherein before and/or after the contacting, the poly(arylene sulfide) reaction mixture and/or downstream product thereof comprise less than about 0.025 wt. % thiophenol, based on the total weight of the poly(arylene sulfide) reaction mixture and/or downstream product thereof. In an embodiment, the process for producing a poly(arylene sulfide) polymer can further comprise evaporating at least a portion of the poly(arylene sulfide) reaction mixture downstream product to yield a recovered polar organic compound, wherein the recovered polar organic compound can comprise less than about 0.025 wt. % thiophenol, based on the total weight of the recovered polar organic compound. In an embodiment, at least a portion of the recovered polar organic compound can be recycled/reused in a subsequent polymerization process for producing a poly(arylene sulfide) polymer. In an embodiment, at least a portion of the recovered polar organic compound can be recycled/reused in step (a) polymerizing reactants and/or step (b) processing the poly(arylene sulfide) reaction mixture.

In an embodiment, a process of the present disclosure comprises contacting a reactive aryl halide with a poly(arylene sulfide) reaction mixture and/or downstream product thereof to prevent thiophenol formation and/or accumulation. While the present disclosure will be discussed in detail in the context of a process for producing a poly(arylene sulfide) polymer, it should be understood that such process or any steps thereof can be applied in a process for producing any other suitable polymer. The polymer can comprise any polymer compatible with the disclosed methods and materials.

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed. (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogen atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

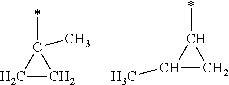

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon-the methylene group in diphenylmethane; oxygen-diphenyl ether; nitrogen-triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

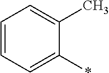 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a -(Ar-S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the -(Ar-S)— unit. In an embodiment, the poly(arylene sulfide) can contain up to 50, 70, 80, 90, 95, 99, or 100 mole percent of the -(Ar-S)— unit. In some embodiments, poly(arylene sulfide) can contain from any minimum mole percent of the -(Ar-S)— unit disclosed herein to any maximum mole percent of the -(Ar-S)— unit disclosed herein; for example, from 5 to 99 mole percent, 30 to 70 mole percent, or 70 to 95 mole percent of the -(Ar-S)— unit. Other ranges for the poly(arylene sulfide) units are readily apparent from the present disclosure. Poly(arylene sulfide) containing less than 100 percent -(Ar-S)— can further comprise units having one or more of the following structures, wherein (*) as used throughout the disclosure represents a continuing portion of a polymer chain or terminal group:

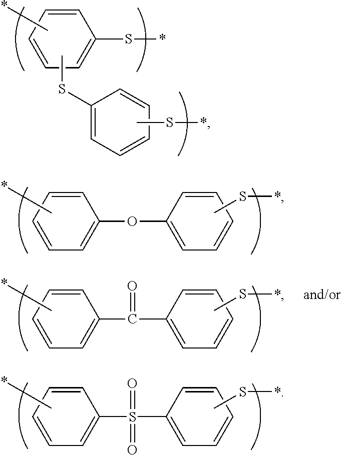

In an embodiment, the arylene sulfide unit can be represented by Formula I.

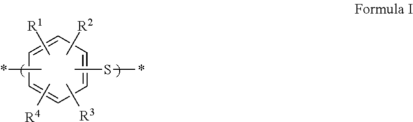

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, a aralkyl group or a substitute aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the -(Ar-S)-unit. Other suitable ranges for the para-phenylene sulfide units will be readily apparent to one of skill in the art with the help of this disclosure. The structure for the para-phenylene sulfide unit can be represented by Formula II.

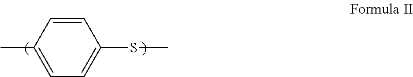

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfone groups, or groups having the following structures:

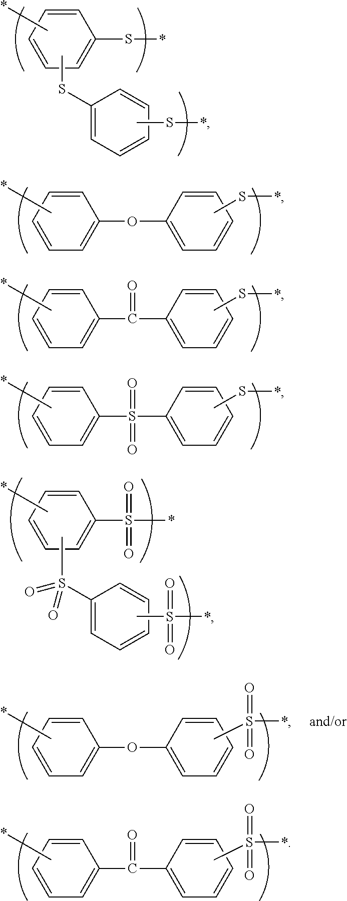

In other embodiments, PPS can comprise up to about 30, 20, 10, or 5 mole percent of units having one or more of the following structures:

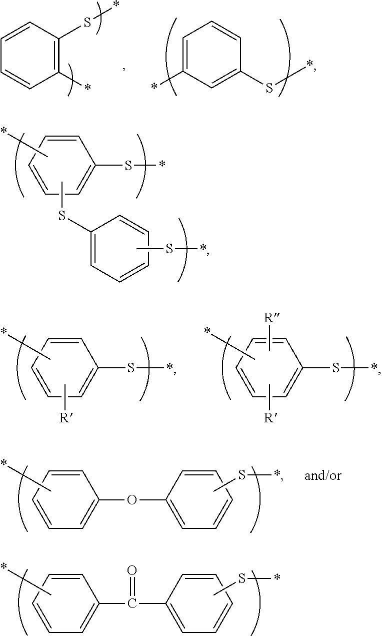

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

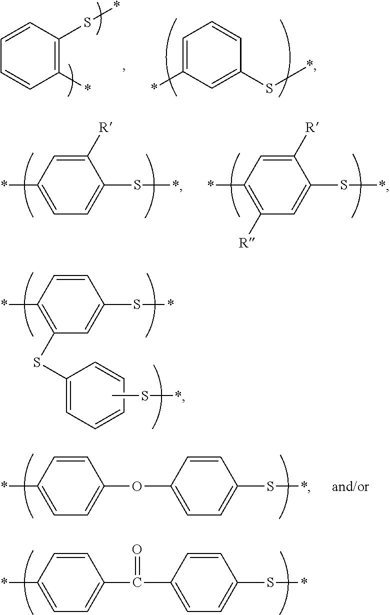

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

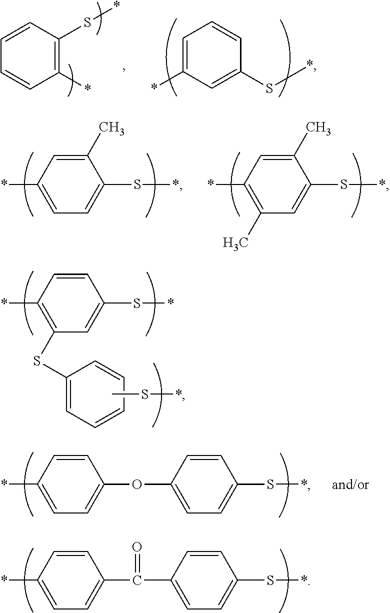

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS can not typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

In an embodiment, the process for producing a poly(arylene sulfide) polymer can comprise a step of polymerizing reactants in a reaction vessel or reactor to produce a poly(arylene sulfide) reaction mixture.

In an embodiment, the step of polymerizing reactants comprises reacting a sulfur source and a dihaloaromatic compound (e.g., a polymerization reaction) in the presence of a polar organic compound to form a reaction mixture (e.g., a polymerization reaction mixture).

In an embodiment, the process for producing a poly(arylene sulfide) polymer comprises reacting a sulfur source and a dihaloaromatic compound in the presence of a polar organic compound to form a reaction mixture (e.g., a poly(arylene sulfide) reaction mixture). In an embodiment, the process for producing a poly(arylene sulfide) polymer comprises polymerizing reactants (e.g., a sulfur source and a dihaloaromatic compound) in a reaction vessel or reactor, to produce a reaction mixture (e.g., a poly(arylene sulfide) reaction mixture), wherein at least a portion of the reactants undergo a polymerization reaction.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens (e.g., dihaloaromatic compounds) which can be employed to produce the poly(arylene sulfide) can be represented by Formula III.

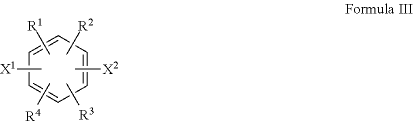

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³, and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O [symbol] NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O [symbol] CH₃NHCH₂CH₂CH₂CO₂Na(SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

Generally, the ratio of reactants employed in the polymerization process to produce a poly(arylene sulfide) can vary widely. However, the typical molar equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound (e.g., trihaloaromatic compound) optionally employed as a reactant can be any amount to achieve a desired degree of branching to give a desired poly(arylene sulfide) melt flow. Generally, up to about 0.02 moles of polyhalo-substituted aromatic compound per mole of halogenated aromatic compound having two halogens can be employed. As will be appreciated by one of skill in the art, and with the help of this disclosure, generally, the flow properties of a polymer (e.g., melt flow, flow rate, etc.) correlate with the degree of branching (e.g., the use of a polyhalo-substituted aromatic compound could cause branching and lower the flow rate). If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 moles of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure can be in the range of from about 0 psig to about 400 psig; alternatively, in the range of from about 30 psig to about 300 psig; or alternatively, in the range of from about 100 psig to about 250 psig.

The polymerization can be terminated by cooling the reaction mixture (removing heat) to a temperature below that at which substantial polymerization takes place. In some instances the cooling of the reaction mixture also can begin the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

The poly(arylene sulfide) reaction mixture can be cooled using a variety of methods. In an embodiment, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid (e.g., a quench liquid) comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) reaction mixture. In yet other embodiments, the polymerization can be terminated by adding a solvent(s) other than water or the polar organic compound to the poly(arylene sulfide) reaction mixture and cooling the poly(arylene sulfide) reaction mixture. Processes for preparing poly(arylene sulfide) which utilize the addition of water, polar organic compound, and/or other solvent(s) to terminate the reaction can be referred to as a quench termination process. The cooling of the reaction mixture can be facilitated by the use of reactor jackets or coils. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

In an embodiment, a process for producing a poly(arylene sulfide) polymer can comprise a step of processing at least a portion of the poly(arylene sulfide) reaction mixture to obtain a poly(arylene sulfide) reaction mixture downstream product.

In such embodiment, the step of processing the poly(arylene sulfide) reaction mixture can comprise washing the poly(arylene sulfide) reaction mixture with a polar organic compound and/or water to obtain a poly(arylene sulfide) polymer and a poly(arylene sulfide) reaction mixture downstream product; treating at least a portion of the poly(arylene sulfide) polymer with an aqueous acid solution and/or an aqueous metal cation solution to obtain a treated poly(arylene sulfide) polymer; and drying at least a portion of the poly(arylene sulfide) polymer and/or treated poly(arylene sulfide) polymer to obtain a dried poly(arylene sulfide) polymer.

In an embodiment, a process for producing a poly(arylene sulfide) polymer can comprise a step of washing the poly(arylene sulfide) reaction mixture with a polar organic compound and/or water to obtain a poly(arylene sulfide) polymer and a poly(arylene sulfide) reaction mixture downstream product. In such embodiment, the poly(arylene sulfide) reaction mixture downstream product can comprise a first slurry. In an embodiment, a washing vessel can receive the poly(arylene sulfide) reaction mixture (e.g., the poly(arylene sulfide) reaction mixture can be introduced to a washing vessel), wherein the poly(arylene sulfide) reaction mixture can be washed with a polar organic compound and/or water to obtain a poly(arylene sulfide) polymer and a poly(arylene sulfide) reaction mixture downstream product (e.g., a first slurry). As will be appreciated by one of skill in the art, more than one washing vessel can be used for washing the poly(arylene sulfide) reaction mixture, such as for example two, three, four, five, six, or more washing vessels can be used for washing the poly(arylene sulfide) reaction mixture.

Once the poly(arylene sulfide) has precipitated from solution, a particulate poly(arylene sulfide) can be separated (e.g., recovered, retrieved, obtained, etc.) from the poly(arylene sulfide) reaction mixture (e.g., poly(arylene sulfide) reaction mixture slurry) by any process capable of separating a solid precipitate from a liquid. For purposes of the disclosure herein, the particulate poly(arylene sulfide) separated from the poly(arylene sulfide) reaction mixture will be referred to as “poly(arylene sulfide) polymer particles,” “poly(arylene sulfide) particles,” “particulate poly(arylene sulfide) polymer,” “particulate poly(arylene sulfide),” “poly(arylene sulfide) polymer,” or simply “poly(arylene sulfide).” For purposes of the disclosure herein, poly(arylene sulfide) polymer particles can also be referred to as “raw particulate poly(arylene sulfide) polymer,” “raw particulate poly(arylene sulfide),” “raw poly(arylene sulfide) polymer particles,” “raw poly(arylene sulfide) particles,” “raw poly(arylene sulfide) polymer,” or simply “raw poly(arylene sulfide),” (e.g., “raw PPS”) where further processing steps are contemplated after separation of the polymer particles from the poly(arylene sulfide) reaction mixture.

It should be noted that the process to produce the poly(arylene sulfide) can form a by-product alkali metal halide. The by-product alkali metal halide can be removed during process steps utilized to separate the poly(arylene sulfide) polymer particles. Procedures which can be utilized to separate the poly(arylene sulfide) polymer particles from the reaction mixture slurry can include, but are not limited to, i) filtration, ii) washing the poly(arylene sulfide) polymer particles with a liquid (e.g., water or aqueous solution), or iii) dilution of the reaction mixture with liquid (e.g., water or aqueous solution) followed by filtration and washing the poly(arylene sulfide) polymer particles with a liquid (e.g., water or aqueous solution). For example, in a non-limiting embodiment, the reaction mixture slurry can be filtered to separate the poly(arylene sulfide) polymer particles (containing poly(arylene sulfide) or PPS, and by-product alkali metal halide), which can be slurried in a liquid (e.g., water or aqueous solution) and subsequently filtered to remove the alkali metal halide by-product (and/or other liquid, e.g., water, soluble impurities). Generally, the steps of slurrying the poly(arylene sulfide) polymer particles with a liquid followed by filtration to separate the poly(arylene sulfide) polymer particles can occur as many times as necessary to obtain a desired level of purity of the poly(arylene sulfide) polymer.

In an embodiment, the poly(arylene sulfide) polymer can be separated from the poly(arylene sulfide) reaction mixture by way of a screening process, e.g., passing the poly(arylene sulfide) reaction mixture through a screen (e.g., sieve, mesh, wire screen, wire sieve, wire mesh, etc.), wherein the poly(arylene sulfide) polymer is retained on the screen.

In an embodiment, procedures utilized to recover the poly(arylene sulfide) polymer from the reaction mixture can also yield a liquid phase (e.g., poly(arylene sulfide) reaction mixture downstream product). For purposes of the disclosure herein, such liquid phase will be referred to as “first slurry.” In an embodiment, the first slurry can comprise water, a polar organic compound (e.g., NMP), an alkali metal halide by-product (e.g., salt, NaCl, etc.), poly(arylene sulfide) polymer impurities, a halogenated aromatic compound (e.g., p-dichlorobenzene), a molecular weight modifying agent (e.g., an alkali metal carboxylate, sodium acetate), and the like. Nonlimiting examples of poly(arylene sulfide) polymer impurities include poly(arylene sulfide) fines, poly(arylene sulfide) oligomers, poly(arylene sulfide) low molecular weight polymers, small molecules and by-products from the polymerization process, such as for example sodium N-methyl-4-aminobutanoate (SMAB), N-4-(chlorophenyl)-N-methyl-4-aminobutanoic acid (SCAB acid), sodium hydroxide (NaOH), sodium acetate (NaOAc), and the like, or combinations thereof. As will be appreciated by one of skill in the art, and with the help of this disclosure, while the first slurry is the liquid phase obtained during one or more filtration processes to recover the poly(arylene sulfide) polymer, some insoluble particulates can pass through a filtering device (e.g., a filter, a screen, a sieve, etc.) and be present in such liquid phase (e.g., filtrate), thereby making the liquid phase a slurry. Further, as will be appreciated by one of skill in the art, and with the help of this disclosure, the first slurry can be a very diluted slurry, based on the amount of liquid present in the reaction mixture and the amount of liquid used to wash the poly(arylene sulfide) during the recovery of the poly(arylene sulfide) polymer. Further, as will be appreciated by one of skill in the art, and with the help of this disclosure, the amount and type of liquid present in the first slurry influences the solubility of components of the first slurry, and some slurry components (e.g., salts, NaCl, alkali metal carboxylates, sodium acetate, etc.) can be partially soluble in the first slurry, e.g., a portion of a slurry component can be present in the first slurry as a dissolved component, while another portion of the same slurry component can be present in the first slurry as a solid particle.

In an embodiment, the first slurry can be subjected to further processing, such as for example to recover the polar organic compound, as will be described in detail later herein. The recovered polar organic compound (e.g., recovered NMP) can be recycled/reused in a subsequent polymerization process for the production of poly(arylene sulfide) (e.g., PPS).

In an embodiment, a process for producing a poly(arylene sulfide) polymer can optionally comprise a step of treating at least a portion of the poly(arylene sulfide) polymer (e.g., poly(arylene sulfide) polymer particles) with an aqueous acid solution and/or an aqueous metal cation solution to obtain a treated poly(arylene sulfide) polymer, wherein the treated poly(arylene sulfide) polymer can be recovered from a treatment solution via a separation (e.g., filtration) step.

In an embodiment, the poly(arylene sulfide) polymer can be treated with an aqueous acid solution and/or can be treated with an aqueous metal cation solution, to yield treated poly(arylene sulfide) (e.g., acid treated poly(arylene sulfide), metal cation treated poly(arylene sulfide)). Additionally, the poly(arylene sulfide) polymer can be dried to remove liquid adhering to the poly(arylene sulfide) polymer particles. Generally, the poly(arylene sulfide) polymer which can be treated can be i) the poly(arylene sulfide) polymer particles separated from the reaction mixture or ii) the poly(arylene sulfide) polymer particles which have been washed with a liquid (e.g., water) and filtered to remove the alkali metal halide by-product (and/or other liquid soluble impurities). The poly(arylene sulfide) polymer particles which can be treated can either be liquid-wet or dry; alternatively, liquid-wet; or alternatively, dry.

Acid treatment can comprise a) contacting the poly(arylene sulfide) with water to form a poly(arylene sulfide) slurry, b) contacting the poly(arylene sulfide) slurry with an acidic compound to form an acidic mixture, c) heating the acidic mixture in the substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the poly(arylene sulfide) with an aqueous solution comprising an acidic compound to form an acidic mixture, b) heating the acidic mixture in the substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,644, which is incorporated by reference herein in its entirety.

Generally, the metal cation treatment can comprise a) contacting the poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in the substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in the substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppm to about 10,000 ppm, from about 75 ppm to about 7,500 ppm, or from about 100 ppm to about 5,000 ppm. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the acid treatment process are provided in EP patent publication 0103279 A1, which is incorporated by reference herein in its entirety.

Once the poly(arylene sulfide) has been acid treated and/or metal cation treated, the acid treated and/or metal cation treated poly(arylene sulfide) can be separated from a treatment solution via a filtration step. Generally, the process/steps for recovering the acid treated and/or metal cation treated poly(arylene sulfide) can be the same steps as those for separating and/or isolating the poly(arylene sulfide) polymer particles from the reaction mixture.

Once the poly(arylene sulfide) polymer particles have been recovered (either in raw, acid treated, metal cation treated, or acid treated and metal cation treated form), the poly(arylene sulfide) can be dried and optionally cured. In an embodiment, a process for producing a poly(arylene sulfide) polymer can comprise a step of drying at least a portion of the poly(arylene sulfide) polymer particles to obtain a dried poly(arylene sulfide) polymer.

Generally, the poly(arylene sulfide) drying process can be performed at any temperature which can substantially dry the poly(arylene sulfide), to yield a dried poly(arylene sulfide) polymer. Preferably, the drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) polymer particles to an elevated temperature, below its melting point, in the presence of gaseous oxidizing atmosphere, thereby forming cured poly(arylene sulfide) polymer (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors mold release agents, pigments, titanium dioxide, clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyaphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) described herein can further be processed by melt processing. In an embodiment, melt processing can generally be any process, step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted, that when any process described herein employs more than one melt processing step, that each melt process step is independent of each other and thus each melt processing step can use the same or different melt processing method. Other melt processing methods are known to those having ordinary skill in the art can be utilized as the melt processing step.

The poly(arylene sulfide) can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide) (e.g., PPS). The output of such techniques can include, for example, polymer intermediates or composites including the poly(arylene sulfide) (e.g., PPS), and manufactured product components or pieces formed from the poly(arylene sulfide) (e.g., PPS), and so on. These manufactured components can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation synthetic fibers, textiles, filter fabric for coal boilers, papermaking felts, electrical insulation, specialty membranes, gaskets, and packing materials.

In an embodiment, the process for producing a poly(arylene sulfide) polymer can comprise the step of contacting a reactive aryl halide with at least a portion of the poly(arylene sulfide) reaction mixture and/or downstream product thereof. In such embodiment, before and/or after the contacting, the poly(arylene sulfide) reaction mixture and/or downstream product thereof can comprise less than about 0.025 wt. % thiophenol, alternatively less than about 0.02 wt. % thiophenol, alternatively less than about 0.01 wt. % thiophenol, alternatively less than about 0.001 wt. % thiophenol, or alternatively less than about 0.0001 wt. % thiophenol, based on the total weight of the poly(arylene sulfide) reaction mixture and/or downstream product thereof. In an embodiment, before and/or after the contacting, the poly(arylene sulfide) reaction mixture and/or downstream product thereof does not contain a material amount of thiophenol. In an embodiment, before and/or after the contacting, the poly(arylene sulfide) reaction mixture and/or downstream product thereof can be free of thiophenol, alternatively substantially free of thiophenol, or alternatively essentially free of thiophenol. As will be appreciated by one of skill in the art, and with the help of this disclosure, contacting a reactive aryl halide with at least a portion of the poly(arylene sulfide) reaction mixture and/or downstream product thereof is not meant for removing already formed thiophenol that would be present in the poly(arylene sulfide) reaction mixture and/or downstream product thereof prior to such contacting, but rather to prevent the formation and/or accumulation of thiophenol in the poly(arylene sulfide) reaction mixture and/or downstream product thereof.

In an embodiment, the reactive aryl halide can be contacted with the poly(arylene sulfide) reaction mixture and/or downstream product thereof, wherein a temperature of the poly(arylene sulfide) reaction mixture and/or downstream product thereof can be less than about 200° C., alternatively less than about 175° C., or alternatively less than about 150° C.

In an embodiment, the reactive aryl halide can be contacted with the poly(arylene sulfide) reaction mixture, wherein a temperature of the poly(arylene sulfide) reaction mixture can be less than about 200° C., alternatively less than about 175° C., or alternatively less than about 150° C. In such embodiment, the poly(arylene sulfide) reaction mixture can be cooled down prior to contacting with a reactive aryl halide, as previously described herein (e.g., external cooling; jacket cooling; internal cooling; coil cooling; adding a liquid such as a quench liquid to the reaction vessel, wherein the temperature of the liquid is lower than the temperature of the reaction mixture; and the like; or combinations thereof). As will be appreciated by one of skill in the art, and with the help of this disclosure, when a quench liquid is introduced to the reaction vessel, a heat transfer can occur between the quench liquid and the poly(arylene sulfide) reaction mixture, e.g., heat can be transferred from the poly(arylene sulfide) reaction mixture to the cooler quench liquid, thereby causing the temperature of the poly(arylene sulfide) reaction mixture to decrease. In an embodiment, the poly(arylene sulfide) reaction mixture in the reaction vessel can be cooled down to yield a cooled poly(arylene sulfide) reaction mixture.

In an embodiment, the reactive aryl halide can be added (e.g., introduced) to the reaction vessel, thereby contacting the reactive aryl halide with the poly(arylene sulfide) reaction mixture (e.g., cooled poly(arylene sulfide) reaction mixture). In an alternative embodiment, the reactive aryl halide can be contacted with at least a portion of the poly(arylene sulfide) reaction mixture after removal of at least a portion of the poly(arylene sulfide) reaction mixture from the reaction vessel.

In another embodiment, the reactive aryl halide can be contacted with at least a portion of the poly(arylene sulfide) reaction mixture downstream product (e.g., first slurry). In yet another embodiment, the reactive aryl halide can be contacted with both the poly(arylene sulfide) reaction mixture and the poly(arylene sulfide) reaction mixture downstream product (e.g., first slurry). As will be appreciated by one of skill in the art, and with the help of this disclosure, the first slurry comprises the reactive aryl halide, whether the reactive aryl halide was contacted with the poly(arylene sulfide) reaction mixture, the poly(arylene sulfide) reaction mixture downstream product (e.g., first slurry), or both the poly(arylene sulfide) reaction mixture and the poly(arylene sulfide) reaction mixture downstream product (e.g., first slurry).

In an embodiment, the reactive aryl halide comprises a halogenated aromatic compound, such as for example a monohalogenated aromatic compound, a polyhalogenated aromatic compound, a dihalogenated aromatic compound, a trihalogenated aromatic compound, a tetrahalogenated aromatic compound, or combinations thereof.

In an embodiment, each halide of the reactive aryl halide independently can be chloride, bromide, or iodide; alternatively, chloride; alternatively bromide; or alternatively, iodide. In an embodiment, the halide of the reactive aryl halide can be covalently bonded directly to a carbon atom of an aromatic ring (e.g., aryl, phenyl, naphthyl, etc.).

Nonlimiting examples of reactive aryl halides suitable for use in the present disclosure include monochloro diphenyl sulfone, 4-chlorophenyl phenyl sulfide, 4-chlorobenzophenone, dichloro diphenyl sulfone, 4,4′-dichlorodiphenyl sulfone (DCDPS), dichloro diphenyl sulfide, dichloro diphenyl sulfoxide, dichlorobiphenyl, dibromobiphenyl, p-dibromobenzene, p-diiodobenzene, dichlorobenzonitrile, dichlorobenzoic acid, dichloronaphthalene, dibromonaphthalene, dichlorobenzophenone, trichlorobenzene, 1,2,4-trichlorobenzene (1,2,4-TCB), tribromobenzene, trichloronaphthalene, tetrachlorobenzene, tetrachloronaphthalene, and the like, or combinations thereof.

In an embodiment, the reactive aryl halide can be characterized by a molecular weight of equal to or greater than about 170 Da, alternatively greater than about 180 Da, or alternatively greater than about 200 Da.

In an embodiment, the reactive aryl halide can be characterized by a boiling point of equal to or greater than about 210° C., alternatively greater than about 220° C., or alternatively greater than about 230° C. As will be appreciated by one of skill in the art, and with the help of this disclosure, the boiling point of the reactive aryl halide has to be high enough such that when a portion of the poly(arylene sulfide) reaction mixture and/or downstream product thereof (e.g., first slurry) comprising the reactive aryl halide is evaporated (e.g., removed by evaporation), the reactive aryl halide (or most of the reactive aryl halide) does not evaporate. Further, as will be appreciated by one of skill in the art, and with the help of this disclosure, the reactive aryl halide (or most of the reactive aryl halide) does not form an azeotrope with components of the poly(arylene sulfide) reaction mixture and/or downstream product thereof (e.g., first slurry) that are being evaporated (e.g., a polar organic compound, water, etc.), e.g., the reactive aryl halide (or most of the reactive aryl halide) is not removed from the first slurry during the evaporating of at least a portion of the first slurry. In an embodiment, the reactive aryl halide can form an azeotrope with the polar organic compound and/or water in an amount of less than about 5 wt. %, alternatively less than about 4 wt. %, alternatively less than about 3 wt. %, alternatively less than about 2 wt. %, alternatively less than about 1 wt. %, alternatively less than about 0.5 wt. %, alternatively less than about 0.1 wt. %, alternatively less than about 0.01 wt. %, alternatively less than about 0.001 wt. %, alternatively less than about 0.0001 wt. %, or alternatively about 0 wt. %, based on the total weight of the reactive aryl halide present in the poly(arylene sulfide) reaction mixture and/or downstream product thereof (e.g., first slurry).

In an embodiment, the reactive aryl halide can be reactive towards a nucleophile, such as for example a nucleophile present in a poly(arylene sulfide) polymer and/or poly(arylene sulfide) polymer impurities (e.g., poly(arylene sulfide) fines, poly(arylene sulfide) oligomers, poly(arylene sulfide) low molecular weight polymers, etc.). Nonlimiting examples of nucleophiles present in a poly(arylene sulfide) polymer and/or poly(arylene sulfide) polymer impurities include a sulfur nucleophile, an oxygen nucleophile, a nitrogen nucleophile, and the like, or combinations thereof. As will be appreciated by one of skill in the art, and with the help of this disclosure, the reactive aryl halide can undergo a nucleophilic aromatic substitution reaction, wherein the halide group of the reactive aryl halide is a leaving group. Further, as will be appreciated by one of skill in the art, and with the help of this disclosure, the nucleophilic aromatic substitution reaction that the reactive aryl halide can participate in does not usually occur at ambient temperatures (e.g., room temperature) and it could require an energy input in the form of heat for such reaction (e.g., nucleophilic aromatic substitution reaction) to occur. Further, as will be appreciated by one of skill in the art, and with the help of this disclosure, while the temperature of the poly(arylene sulfide) reaction mixture and/or downstream product thereof is below about 200° C., it is believed that it is unlikely for the nucleophilic aromatic substitution reaction involving the reactive aryl halide and the poly(arylene sulfide) polymer and/or poly(arylene sulfide) polymer impurities to occur in part due to the poly(arylene sulfide) polymer and/or poly(arylene sulfide) polymer impurities being generally insoluble in most solvents at temperatures below about 200° C. Without wishing to be limited by theory, a sulfur nucleophile, such as for example a sulfur atom present at the ends of a polymer chain in the poly(arylene sulfide) polymer and/or poly(arylene sulfide) polymer impurities (e.g., poly(arylene sulfide) fines, poly(arylene sulfide) oligomers, poly(arylene sulfide) low molecular weight polymers, etc.) can react with a reactive aryl halide in a nucleophilic aromatic substitution reaction, thereby preventing the formation of thiophenol. In an embodiment, the nucleophile comprises a sulfur nucleophile. Without wishing to be limited by theory, a reactive aryl halide can react with any forming and/or formed thiophenol in the poly(arylene sulfide) reaction mixture and/or downstream product thereof, and thereby can prevent the accumulation of thiophenol.

In an embodiment, the reactive aryl halide can be more reactive towards a nucleophile (e.g., sulfur nucleophile, oxygen nucleophile, nitrogen nucleophile, etc.) present in a poly(arylene sulfide) polymer when compared to a reactivity of the dihaloaromatic compound towards a nucleophile (e.g., sulfur nucleophile, oxygen nucleophile, nitrogen nucleophile, etc.) present in a poly(arylene sulfide) polymer. As will be appreciated by one of skill in the art, and with the help of this disclosure, the poly(arylene sulfide) reaction mixture and/or downstream product thereof can comprise a small amount of unreacted dihaloaromatic compound that was present in the reaction vessel during the step of polymerizing reactants, e.g., one of the reactants comprises a dihaloaromatic compound, and a portion of the dihaloaromatic compound might not participate in the polymerization reaction, and consequently a portion of the dihaloaromatic compound could be found in the poly(arylene sulfide) reaction mixture and/or downstream product thereof. Further, as will be appreciated by one of skill in the art, and with the help of this disclosure, the dihaloaromatic compound and the reactive aryl halide can both react with a nucleophile (e.g., sulfur nucleophile, oxygen nucleophile, nitrogen nucleophile, etc.) present in a poly(arylene sulfide) polymer, however, if the reactive aryl halide is more reactive than the dihaloaromatic compound towards the nucleophile, then the nucleophile could preferentially react with the reactive aryl halide versus reacting with the dihaloaromatic compound.

In an embodiment, a reactive aryl halide can be contacted with the poly(arylene sulfide) reaction mixture and/or downstream product thereof in an amount of less than about 2 wt. % reactive aryl halide, alternatively less than about 1 wt. %, alternatively less than about 0.5 wt. %, based on the total weight of the poly(arylene sulfide) reaction mixture and/or downstream product thereof.

In an embodiment, the process for producing a poly(arylene sulfide) polymer can comprise a step of removing at least a portion of the first slurry (e.g., evaporating at least a portion of a liquid phase of a first slurry) to obtain a by-product slurry and one or more vapor fractions. In an embodiment, at least a portion of the first slurry comprising the reactive aryl halide is evaporated to obtain a by-product slurry and one or more vapor fractions.

In an embodiment, the by-product slurry can comprise slurry particulates, dissolved salts (e.g., dissolved NaCl, dissolved alkali metal carboxylates, dissolved sodium acetate, etc.), a polar organic compound, water, and the like. As will be appreciated by one of skill in the art, and with the help of this disclosure, at least a portion of the slurry particulates present in the by-product slurry have also been present in the first slurry. Further, as will be appreciated by one of skill in the art, and with the help of this disclosure, during the evaporating of at least a portion of the first slurry to obtain a by-product slurry, some of the particulates present in the first slurry can combine (e.g., aggregate, agglomerate, stick together, etc.) to produce the slurry particulates present in the by-product slurry. Without wishing to be limited by theory, during the evaporating of at least a portion of the first slurry to obtain a by-product slurry, some compounds that might be at least partially soluble in the first slurry, might not be as soluble in the by-product slurry and might precipitate out of the solution, due to either a reduction in liquid volume and/or a modification in the composition of a liquid phase of the by-product slurry when compared to a liquid phase of the first slurry. In an embodiment, the slurry particulates of the by-product slurry can comprise an alkali metal halide by-product (e.g., salt, NaCl, etc.), poly(arylene sulfide) polymer impurities, a molecular weight modifying agent (e.g., an alkali metal carboxylate, sodium acetate), and the like, or combinations thereof. As will be appreciated by one of skill in the art, and with the help of this disclosure, the amount and type of liquid present in the by-product slurry influences the solubility of components of the by-product slurry, and some slurry components (e.g., salts, NaCl, alkali metal carboxylates, sodium acetate, etc.) can be partially soluble in the by-product slurry, e.g., a portion of a slurry component can be present in the by-product slurry as a dissolved component (e.g., dissolved salt), while another portion of the same slurry component can be present in the by-product slurry as a solid particulate (e.g., slurry particulate).

In an embodiment, the reactive aryl halide can react with the poly(arylene sulfide) polymer impurities (e.g., poly(arylene sulfide) fines, poly(arylene sulfide) oligomers, poly(arylene sulfide) low molecular weight polymers, etc.) during evaporating at least a portion of the first slurry, thereby reducing or preventing formation and/or accumulation of thiophenol. Without wishing to be limited by theory, it is expected that all or almost all of the reactive aryl halide can undergo a nucleophilic aromatic substitution reaction involving at least some of the poly(arylene sulfide) polymer impurities (e.g., poly(arylene sulfide) fines, poly(arylene sulfide) oligomers, poly(arylene sulfide) low molecular weight polymers) during the evaporating of at least a portion of the first slurry, thereby reducing or preventing thiophenol formation and/or accumulation during such evaporating of at least a portion of the first slurry.

In an embodiment, the step of evaporating at least a portion of the first slurry (e.g., evaporating at least a portion of a liquid phase of a first slurry) to obtain a by-product slurry and one or more vapor fractions can be accomplished by heating the first slurry, such as for example by external heating; by placing the first slurry in a jacketed container wherein hot water and/or steam can be run through a jacket of such container; by electrical heating; by internal heating; by contacting steam with a portion of the first slurry; and the like; or combinations thereof.

In an embodiment, the evaporating of the first slurry can be carried out at a temperature of from about 50° C. to about 300° C., alternatively from about 100° C. to about 283° C., alternatively from about 125° C. to about 250° C., or alternatively from about 150° C. to about 225° C. In an embodiment, the evaporating of the first slurry can be carried out at various pressures, ranging from vacuum to pressures over the atmospheric pressure. As will be appreciated by one of skill in the art, and with the help of this disclosure, the temperature at which the evaporating of at least a portion of the first slurry can be carried out at is limited in part by the fact that the higher the temperature, the higher the possibility of thiophenol formation during such evaporating step. Without wishing to be limited by theory, the presence of the reactive aryl halide in the first slurry, which reactive aryl halide prevents thiophenol formation and/or accumulation during the evaporating step, could enable the use of a higher temperature for the evaporating of at least a portion of the first slurry. In an embodiment, the evaporating of the first slurry can be carried out at a temperature that could be increased by from about 50° C. to about 250° C., alternatively by from about 75° C. to about 225° C., or alternatively by from about 100° C. to about 200° C., when compared to a temperature used for evaporating of an otherwise similar first slurry lacking the reactive aryl halide.

In an embodiment, the step of evaporating at least a portion of the first slurry (e.g., evaporating at least a portion of a liquid phase of a first slurry) can yield one or more vapor fractions. As will be appreciated by one of skill in the art, and with the help of this disclosure, a vapor fraction can condense (i.e., change physical state from gas phase into liquid phase) to form a liquid fraction. In an embodiment, the one or more vapor fractions can yield one or more first liquid fractions, wherein the one or more vapor fractions or first liquid fractions can comprise water, a halogenated aromatic compound, a polar organic compound (e.g., a recovered polar organic compound), or combinations thereof. In an embodiment, the one or more vapor fractions can comprise a recovered polar organic compound. As will be appreciated by one of skill in the art, and with the help of this disclosure, the higher temperature that can be used during the evaporating of at least a portion of the first slurry due to the presence of the reactive aryl halides in the first slurry can lead to more efficient recovery and possibly a larger amount of vapor fractions, when compared to the efficiency and amount of vapor fractions recovered by evaporating a similar first slurry lacking the reactive aryl halide.

In an embodiment, the first liquid fractions can be further subjected to a step for the recovery of the halogenated aromatic compound and/or polar organic compound (e.g., a distillation step), to yield a recovered halogenated aromatic compound and/or a recovered polar organic compound (e.g., recovered NMP). In an embodiment, at least a portion of the recovered halogenated aromatic compound and/or the recovered polar organic compound can be recycled/reused in subsequent polymerization processes for the production of poly(arylene sulfide) (e.g., PPS). In an embodiment, the step of evaporating at least a portion of the first slurry can comprise two or more sub-steps, such as for example a first sub-step wherein an aqueous liquid fraction is recovered, followed by a second sub-step, wherein an organic liquid fraction is recovered.

In an embodiment, the recovered polar organic compound can be further processed (e.g., dehydrated, purified, etc.) and/or recycled/reused in subsequent polymerization processes for the production of poly(arylene sulfide) (e.g., PPS). In an embodiment, the recovered polar organic compound can be further subjected to a dehydration process (e.g., water removal process) and/or to a purification process (e.g., distillation) prior to being recycled/reused in a subsequent polymerization process for the production of poly(arylene sulfide) (e.g., PPS).

In an embodiment, at least a portion of the recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) polymer reaction mixture downstream product. In an embodiment, at least a portion of the recovered polar organic compound can be recycled/reused in a step of washing the poly(arylene sulfide) reaction mixture with a polar organic compound and/or water to obtain a poly(arylene sulfide) polymer and a first slurry. In an embodiment, the recovered polar organic compound can comprise less than about 0.025 wt. % thiophenol, alternatively less than about 0.02 wt. % thiophenol, alternatively less than about 0.01 wt. % thiophenol, alternatively less than about 0.001 wt. % thiophenol, or alternatively less than about 0.0001 wt. % thiophenol, based on the total weight of the recovered polar organic compound. In an embodiment, the recovered polar organic compound does not contain a material amount of thiophenol. In an embodiment, the recovered polar organic compound can be free of thiophenol, alternatively substantially free of thiophenol, or alternatively essentially free of thiophenol.

In an embodiment, a process for producing a poly(arylene sulfide) polymer can further comprise a step of evaporating (e.g., removing) at least a portion of the by-product slurry to yield salt solids particulates and a second recovered polar organic compound (e.g., a second recovered NMP). In an embodiment, at least a portion of the second recovered polar organic compound can be recycled/reused in subsequent polymerization processes for the production of poly(arylene sulfide) (e.g., PPS).

In an embodiment, the second recovered polar organic compound can be further processed (e.g., dehydrated, purified, etc.) and/or recycled/reused in subsequent polymerization processes for the production of poly(arylene sulfide) (e.g., PPS). In an embodiment, the second recovered polar organic compound can be further subjected to a dehydration process (e.g., water removal process) and/or to a purification process (e.g., distillation) prior to being recycled/reused in subsequent polymerization processes for the production of poly(arylene sulfide) (e.g., PPS).

In an embodiment, at least a portion of the second recovered polar organic compound can be recycled/reused in a step of polymerizing reactants in a reaction vessel to produce a poly(arylene sulfide) reaction mixture and/or a step of processing the poly(arylene sulfide) reaction mixture to obtain a poly(arylene sulfide) reaction mixture downstream product. In an embodiment, at least a portion of the second recovered polar organic compound can be recycled/reused in a step of washing the poly(arylene sulfide) reaction mixture with a polar organic compound and/or water to obtain a poly(arylene sulfide) polymer and a first slurry.

In an embodiment, the salt solids particulates recovered from the by-product slurry can be further solubilized in water and/or an aqueous solution, to yield a salt solution. In such embodiment, the alkali metal halide by-product (e.g., salt, NaCl, etc.), as well as any other salts that are present in the salt solids particulates (e.g., a molecular weight modifying agent, an alkali metal carboxylate, sodium acetate, etc.) can be solubilized in the water and/or an aqueous solution, to yield the salt solution, while some of the poly(arylene sulfide) polymer impurities (e.g., poly(arylene sulfide) fines, poly(arylene sulfide) oligomers, poly(arylene sulfide) low molecular weight polymers, etc.) can remain as a solid phase in the salt solution. In an embodiment, the salt solution can be further filtered to remove at least a portion of the poly(arylene sulfide) polymer impurities. In an embodiment, the poly(arylene sulfide) polymer impurities can be discarded or disposed of. In an embodiment, the salt solution can be discarded or disposed of. In an alternative embodiment, the salt solution can be further recycled.

In an embodiment, a process for producing a poly(phenylene sulfide) polymer can comprise (a) polymerizing reactants in a reaction vessel to produce a poly(phenylene sulfide) reaction mixture; (b) processing at least a portion of the poly(phenylene sulfide) reaction mixture to obtain a poly(phenylene sulfide) reaction mixture downstream product; and (c) contacting a reactive aryl halide with at least a portion of the poly(phenylene sulfide) reaction mixture and/or downstream product thereof, wherein before and/or after the contacting, the poly(phenylene sulfide) reaction mixture and/or downstream product thereof comprise less than about 0.025 wt. % thiophenol, based on the total weight of the poly(phenylene sulfide) reaction mixture and/or downstream product thereof. In such embodiment, the reactive aryl halide can comprise 1,2,4-trichlorobenzene.

In an embodiment, a process for producing a poly(phenylene sulfide) polymer can comprise (a) reacting a sulfur source and a dihaloaromatic compound in the presence of N-methyl-2-pyrrolidone to form a poly(phenylene sulfide) reaction mixture; (b) washing at least a portion of the poly(phenylene sulfide) reaction mixture with N-methyl-2-pyrrolidone and/or water to obtain a poly(phenylene sulfide) polymer and a first slurry; and (c) contacting a reactive aryl halide with at least a portion of the first slurry, wherein before and/or after the contacting, the first slurry comprises less than about 0.025 wt. % thiophenol, based on the total weight of the first slurry. In such embodiment, the reactive aryl halide can comprise dichloro diphenyl sulfone (e.g., DCDPS).

In an embodiment, a process for producing a poly(phenylene sulfide) polymer can comprise (a) polymerizing reactants in a reaction vessel to produce a poly(phenylene sulfide) reaction mixture; (b) cooling the poly(phenylene sulfide) reaction mixture in the reaction vessel to a temperature of less than about 200° C. to yield a cooled poly(phenylene sulfide) reaction mixture; and (c) contacting a reactive aryl halide with the cooled poly(phenylene sulfide) reaction mixture in the reaction vessel, wherein before and/or after the contacting, the poly(phenylene sulfide) reaction mixture comprises less than about 0.025 wt. % thiophenol, based on the total weight of the poly(phenylene sulfide) reaction mixture. In such embodiment, the reactive aryl halide can comprise 4-chlorophenyl phenyl sulfide.

In an embodiment, a process for producing a poly(phenylene sulfide) polymer can comprise (a) polymerizing reactants in a reaction vessel to produce a poly(phenylene sulfide) reaction mixture; (b) removing at least a portion of the reaction mixture from the reaction vessel to yield a removed portion of the reaction mixture; (c) processing at least a portion of the removed portion of the reaction mixture to obtain a downstream processed product; and (d) contacting a reactive aryl halide with at least a portion of the (i) poly(phenylene sulfide) reaction mixture, (ii) removed portion of the reaction mixture, and/or (iii) downstream processed product, wherein before and/or after the contacting, the (i) poly(phenylene sulfide) reaction mixture, (ii) removed portion of the reaction mixture, and/or (iii) downstream processed product comprise less than about 0.025 wt. % thiophenol, based on the total weight of the downstream processed product. In such embodiment, the reactive aryl halide can comprise monochloro diphenyl sulfone.

In an embodiment, a process for producing a poly(phenylene sulfide) polymer can comprise (a) polymerizing reactants in a reaction vessel to produce a poly(phenylene sulfide) reaction mixture; (b) removing at least a portion of the reaction mixture from the reaction vessel to yield a removed portion of the reaction mixture; (c) processing at least a portion of the removed portion of the reaction mixture to obtain a solid poly(phenylene sulfide) polymer and a liquid product; and (d) contacting a reactive aryl halide with at least a portion of the (i) poly(phenylene sulfide) reaction mixture, (ii) removed portion of the reaction mixture, and/or (iii) liquid product, wherein before and/or after the contacting, the (i) poly(phenylene sulfide) reaction mixture, (ii) removed portion of the reaction mixture, and/or (iii) liquid product comprise less than about 0.025 wt. % thiophenol, based on the total weight of the liquid product. In such embodiment, the reactive aryl halide can comprise dichloro diphenyl sulfoxide.

In an embodiment, the process for producing a poly(arylene sulfide) polymer as disclosed herein advantageously displays improvements in one or more process characteristics when compared to an otherwise similar process lacking a step of contacting a reactive aryl halide with at least a portion of the poly(arylene sulfide) reaction mixture and/or downstream product thereof. For example, the temperature to which a first slurry can be heated is limited by the formation of thiophenol at higher temperatures. However, the use of a reactive aryl halide as disclosed herein can advantageously allow for the use of a higher temperature for the evaporating of at least a portion of the first slurry, when compared to the temperature used for evaporating an otherwise similar first slurry lacking the reactive aryl halide.

In an embodiment, the use of a reactive aryl halide as disclosed herein can advantageously prevent the degradation of the poly(arylene sulfide) polymer and/or the poly(arylene sulfide) polymer impurities (e.g., poly(arylene sulfide) fines, poly(arylene sulfide) oligomers, poly(arylene sulfide) low molecular weight polymers, etc.), thereby preventing the formation and/or accumulation of thiophenol.

In an embodiment, the use of a reactive aryl halide as disclosed herein can advantageously lead to a higher yield of recovery of vapor fractions during the evaporating of at least a portion of the first slurry. Additional advantages of the process for the production of a poly(arylene sulfide) polymer as disclosed herein can be apparent to one of skill in the art viewing this disclosure.

### EXAMPLES

The subject matter having been generally described, the following examples are given as particular embodiments of the disclosure and to demonstrate the practice and advantages thereof. It is understood that the examples are given by way of illustration and are not intended to limit the specification of the claims to follow in any manner.

The effect of contacting a reactive aryl halide with a poly(arylene sulfide) reaction mixture and/or downstream product thereof was studied. More specifically, the effect of contacting 4,4′-dichlorodiphenyl sulfone (DCDPS) and/or 1,2,4-trichlorobenzene (1,2,4-TCB) with a poly(phenylene sulfide) (PPS) reaction mixture and/or downstream product thereof (e.g., PPS first slurry or PPS slime) was investigated. For purposes of the disclosure herein, the PPS first slurry will be referred to as “PPS slime” throughout the Examples section. Further, for purposes of the disclosure herein, PPS slime refers to material that passes through any filters when isolating a solid PPS polymer. General reaction conditions were previously described herein.

For example, PPS can be prepared according to the following recipe. To a 1-liter titanium reactor was added 0.666 moles of NaSH (62.50 g), 0.680 moles of NaOH (27.61 g), and 1.665 moles of N-methyl-2-pyrrolidone (165.05 g). The reactor was closed and the reactor stirrer operated at 175 revolutions per minute (rpm). The reactor was purged of air by charging the reactor with nitrogen to 50 psig and then depressurizing the reactor for a total of five pressurization/depressurization cycles. Then the reactor was charged with nitrogen to 200 psig and depressurized for a total of five pressurization/depressurization cycles. Water was then removed (also referred to as dehydration) from the reactor by heating the reactor to approximately 140° C. The dehydration line was then opened, a nitrogen flow rate of 32 cc/minute was introduced into the reactor, and the reactor was heated to approximately 200° C. over a period of 95 minutes. During this time 25 mL of liquid was collected. Gas chromatography of the collected liquid indicated that the liquid contained 96 wt. % water and 4.0 wt. % N-methyl-2-pyrrolidone (NMP). Upon completion of the dehydration, the dehydration line was closed, the reactor was charged to 50 psig with nitrogen, and the nitrogen flow was discontinued. The reactor was then heated to 250° C. To a 0.3 liter charging vessel was added 0.666 moles of para-dichlorobenzene (98.0 g) and 0.25 moles of N-methyl-2-pyrrolidone (25.0 g). The charging vessel was then purged with nitrogen, closed, and placed in a heated bath (at approximately 100° C.) until it was to be charged to the reactor. When the reactor reached 250° C., the contents of the charging vessel were then pressured (nitrogen pressure) into the reactor. The charging vessel was rinsed with 0.5 moles of N-methyl-2-pyrrolidone (49.56 g) and the rinse was pressured with nitrogen and then delivered into the reactor. Once the contents of the charging reactor were in the reactor, the reactor temperature was increased to 250° C. and was maintained at 250° C. for approximately four hours. At the end of the 4 h period, the reaction was quenched by cooling below 200° C., and a PPS reaction mixture was obtained. The obtained PPS reaction mixture was then transferred to a holding tank for further processing.

The PPS reaction mixture was a slurry comprising PPS, NMP, salt (NaCl), sodium acetate if present, and polymer impurities (e.g., PPS oligomers, PPS cyclics). The PPS reaction mixture was further processed by subsequent washings on rotary shaker screens. These washings included varying amounts of NMP to remove the PPS oligomers and cyclics and varying amounts of water to remove salt and sodium acetate. The first pass across the screen was where the “PPS slime” was collected. The filtrate was considered to be the PPS slime (e.g., first slurry).

The effect of contacting the PPS slime with reactive aryl halides was investigated by studying the decomposition (e.g., degradation) of PPS slimes in the presence of DCDPS and/or 1,2,4-TCB. Testing of PPS slimes was performed in a 300 cc stainless steel reactor. The reactor was charged with the reactive aryl halide (1.0 g (3.5 mmol) of DCDPS, or 0.72 g (3.9 mmol) of 1,2,4-TCB), 50 g of PPS slime, 10.0 g of distilled water and 75 g of N-methyl-2-pyrrolidone (NMP). The reactor was then sealed and stirred at 250 rpm under a nitrogen purge. The reactor was pressurized with nitrogen to 100 psi and then depressurized for a total of ten pressurization/depressurization cycles. The reactor was equipped with a temperature controller. The temperature controller was set to 235° C. When the reactor reached 135° C., the vent line to a condenser was opened and a flow of nitrogen at 2 mL/min was opened. The water was distilled out and the dehydration continued until the reactor reached 200° C. The vent line to the condenser was then closed and the reactor was pressurized to 100 psig with nitrogen. The temperature controller was then set to the desired testing temperature and held for the desired amount of time. In order to sample the reactor contents, the reactor was cooled to room temperature at the end of a heat cycle, generally overnight, and opened and sampled with a pipette. The reactor was then resealed and degassed by pressurizing/depressurizing with nitrogen to 100 psig ten times before reheating. This process was done at each sample interval. Degradation/decomposition was tested by contacting the PPS slime with DCDPS and/or 1,2,4-TCB for various lengths of time. Experiments had a hold time of 16 or 40 hours. Experiments with a 16 hour hold time were sampled at 4, 10, and/or 16 hours. Experiments with a 40 hour hold time were sampled at the end of 40 hours.

A 500 g amount of PPS reaction mixture was charged into a 1 L titanium reactor and degassed at 100 psig five times and at 250 psig three times. The mixture was heated to the desired temperature, at which point the reactive aryl halide was added to the previously degassed reactor by using 1 g of DCDPS in 25 g of NMP. The reactor was then held at temperature (95° C.-179.5° C.) for the desired amount of time (2-63 minutes) as shown in Table 1. Once below 170° C., the reactor was allowed to further cool overnight under ambient conditions. The next day the reactor was opened and reactor contents were removed. The reactor contents were screened using a 100 mesh screen (nominal opening size of 0.152 mm) and washed with hot NMP, 6 hot water washes, 1 hot acid wash (3.0 g of glacial acetic acid/L) and a subsequent water wash to remove any residual acetic acid, and a PPS polymer was obtained. The PPS polymer was dried in a vacuum oven overnight at 100° C. prior to analysis.

A 1:1 by volume mixture of NMP and water was distilled using a standard short path column equipped with a water cooled condenser and a cow receiver. The mixture was placed in a distillation kettle. The mixture was spiked with reactive aryl halide and two fractions were collected: one from room temperature (RT) to 115° C. and a second one from 115° C. to 205° C. The second fraction was allowed to collect at 205° C. for several minutes. The distillation was always stopped prior to the kettle becoming dry. For DCDPS, the mixture contained 25 g NMP, 25 g water, and 0.8 g DCDPS. For 1,2,4-TCB, the mixture contained 12 g NMP, 12 g water, and 7 g 1,2,4-TCB.

### Example 1

The effect of contacting a reactive aryl halide (e.g., DCDPS and/or 1,2,4-TCB) with a PPS slime (e.g., PPS first slurry) was studied. More specifically, the ability of the reactive aryl halide to enhance stability of the PPS slimes with respect to thiophenol formation was investigated. As will be appreciated by one of skill in the art, and with the help of this disclosure, the higher the stability of a PPS slime, the lower the amount of thiophenol formed during processing of the PPS slime. The PPS slimes were subjected to degradation/decomposition testing as described previously herein.

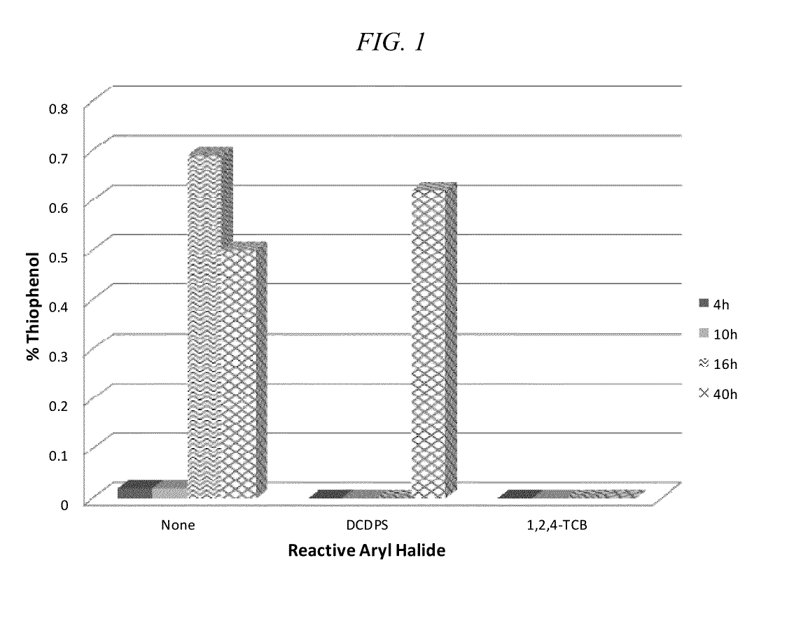

Reactive aryl halide, 25 g of NMP, and 10 g of water were added to 50 g of PPS slime to form a PPS slime mixture. The PPS slime mixture was then dehydrated by heating the reactor to at 203° C. under a flow of nitrogen to remove any p-dichlorobenzene or 1,4-dichlorobenzene (e.g., 1,4-DCB) and water present in the reaction mixture. The PPS slime mixture was then subjected to heating at 265° C. and sampled at 4 h, 10 h, and 16 h. The samples collected at various time points were analyzed by gas chromatography using an Agilent® 7890 capillary gas chromatograph (GC) equipped with flame ionization detector (GC-FID). The analysis was performed using a DB-5 column (30 m x 0.32 mm) with a 1.0 μm film thickness. The inlet temperature was set at 325° C. and held at 6 psi with a 15:1 split ratio. The FID detector temperature was held at 325° C. with the following gas flow settings: 30 mL/min H₂, 380 mL/min air, and 25 mL/min He. After the sample was injected, the oven temperature was ramped from 60° C. to 320° C. at a 0.5° C./min ramp rate. All reported values from GC analysis are in wt. %. The results from this trial at 265° C. can be observed in FIG. 1. The control reaction did not include any reactive aryl halide and produced significant quantities of thiophenol, as expected. The DCDPS and 1,2,4-TCB containing reactions did not produce any detectable amount of thiophenol after 16 h of heating. In order to test the limits of the stabilizing effects that the reactive aryl halide has on PPS slime, additional testing in which fresh PPS slime mixtures were heated for 40 h was completed, and the results are also displayed in FIG. 1. Both the control reaction and the DCDPS containing reaction produced significant amounts of thiophenol at 40 h. However, no thiophenol was detected in the 1,2,4-TCB sample.

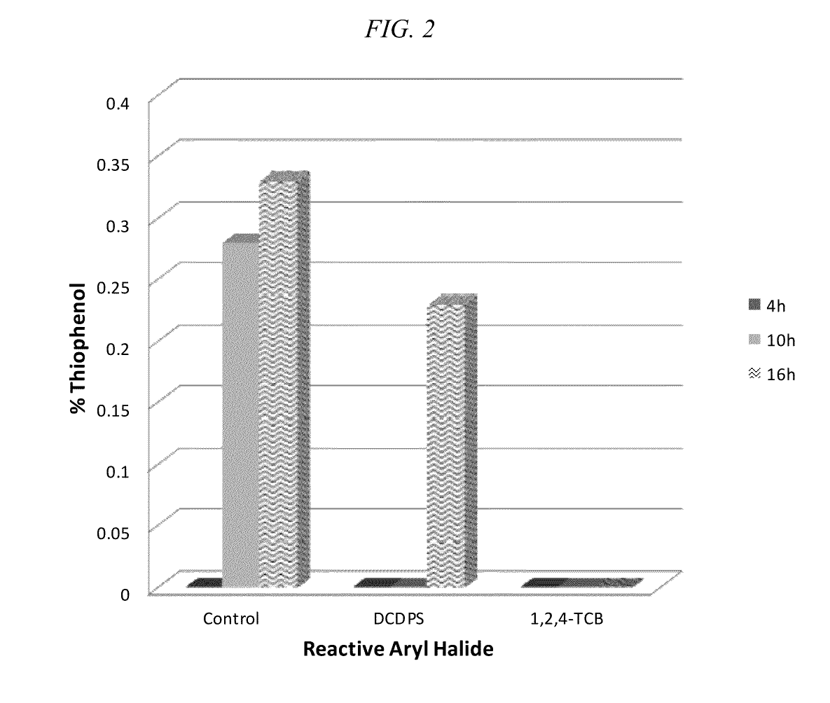

In order to push the system even harder, the PPS slimes were also similarly tested at a higher temperature. A series of degradation/decomposition reaction tests were run at 282° C. The results from this trial at 282° C. are shown in FIG. 2. Again, the 1,2,4-TCB containing mixture proved to be the most stable of the three, with no detectable thiophenol formation. Also, the same behavior for DCDPS was observed, in that thiophenol generation was retarded for a certain amount of time, but eventually thiophenol was produced in quantities similar to the control reaction.

### Example 2

The behavior of the DCDPS and/or 1,2,4-TCB reactive aryl halides during the PPS slime decomposition/degradation testing described in Example 1 was studied. More specifically, the reactive aryl halide content in the PPS slime mixtures at the various temperatures and time points evaluated in Example 1 was investigated.

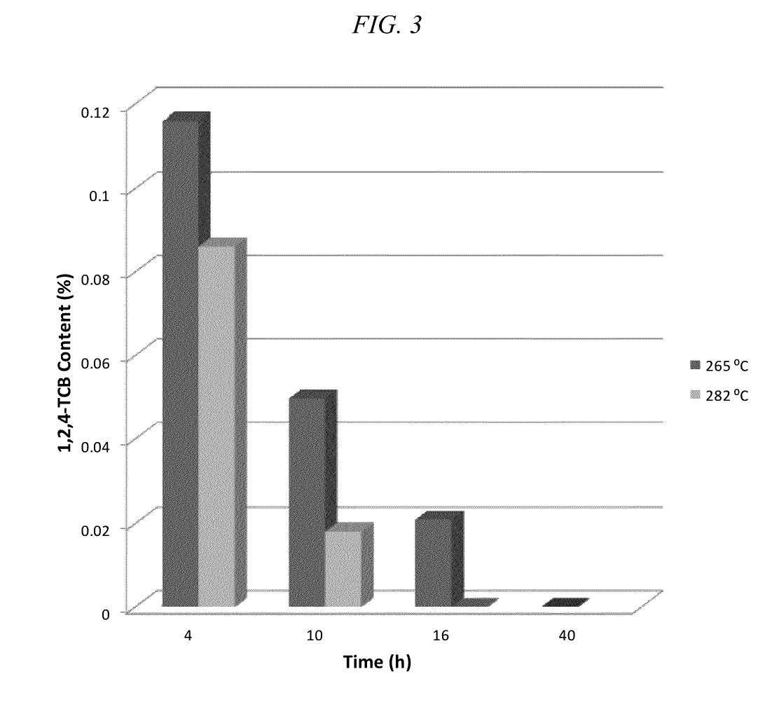

Gas chromatography (GC) analysis of PPS slime reaction mixtures at each sample point was performed using the previously described GC method to determine the presence of any remaining reactive aryl chloride. The DCDPS reactions also formed an impurity with the same retention time as DCDPS, and thus, analysis of DCDPS consumption during the testing sequence was not possible. Analysis of the 1,2,4-TCB consumption was not hindered by the presence of any impurities, and the resulting data are shown in FIG. 3. Testing of the reaction mixtures over the specified time intervals showed a reduction in 1,2,4-TCB content as the reaction progressed at 265° C., and all of the 1,2,4-TCB was consumed between 16 h and 40 h. At 282° C. the 1,2,4-TCB was completely consumed by 16 h; however, no thiophenol was detected after 16 h. These results suggests that the stabilizing effect of 1,2,4-TCB addition can be maintained after initial reaction of the 1,2,4-TCB.

Without wishing to be limited by theory, it is believed that the enhanced stability from 1,2,4-TCB can be a result of increased inherent reactivity or number of reactive sites. 1,2,4-TCB has three available reactive sites for reacting with aryl thio groups, whereas DCDPS has only two available reactive sites for reacting with aryl thio groups. Without wishing to be limited by theory, since the reactive aryl halides were added at similar molar ratios to the PPS slimes, this difference in the number of available reactive sites between DCDPS and 1,2,4-TCB can account for the increased stability observed for 1,2,4-TCB. Further, without wishing to be limited by theory, it is also possible that the reactivity of 1,2,4-TCB is higher than the reactivity of DCDPS after the first reactive site is consumed. Further, without wishing to be limited by theory, the remaining chloro functionalities on the 1,2,4-TCB molecule can be more reactive and act as additional stabilizing moieties. However, regardless of the reason, it is quite apparent that 1,2,4-TCB retards thiophenol formation to a much larger extent than DCDPS.

### Example 3

The behavior of the DCDPS and/or 1,2,4-TCB reactive aryl halides during the PPS slime decomposition/degradation testing was studied. More specifically, the reactive aryl halide content in water/NMP mixtures during distillation was investigated as previously described herein.

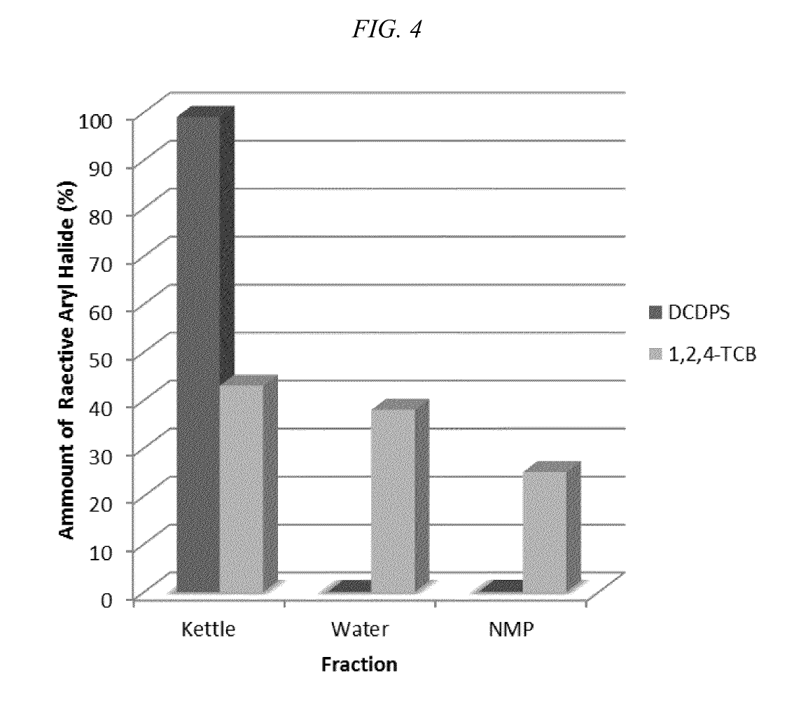

Distillation experiments were conducted to monitor whether the reactive aryl halides would remain in the distillation kettle during water and NMP removal. Without wishing to be limited by theory, it is believed that one reason for thiophenol generation during PPS slime processing (e.g., PPS first slurry processing) is the creation of a 1,4-DCB deficient environment. In order for a reactive aryl halide to be effective in preventing thiophenol formation and/or accumulation during PPS slime processing, such reactive aryl halide must remain present in the vessel where the PPS slime is being processed, specifically after the removal of water and much of the NMP. As such, a distillation of a water and NMP mixture (1:1 by volume) spiked with reactive aryl halide was completed as previously described herein. The results of the distillations are shown in FIG. 4. The data are presented as a relative amount of the initial reactive aryl halide charge found in each fraction: water fraction (room temperature-115° C. cut), NMP fraction (115° C.-205° C. cut), and kettle fraction (e.g., kettle residue) at the end of the distillation. Over 99% of the DCDPS charge remained in the kettle at the end of the distillation. Alternatively, 1,2,4-TCB was found to azeotrope with the water and co-distill with NMP. It did appear that the concentration of 1,2,4-TCB was highest in the kettle, suggesting that a majority of 1,2,4-TCB remained in the PPS slime mixture throughout much of processing.

### Example 4

The properties of PPS polymer that has been contacted with (or exposed to) a reactive aryl halide were studied. More specifically, the flow rate as measured by 1270 ER of PPS polymer samples from PPS reaction mixtures was investigated after contacting the PPS reaction mixture with a reactive aryl halide as previously described herein. The 1270 ER method is a melt flow analysis method similar to flow rate (FR) or high load melt index (HLMI) except that the orifice and load are different. For the 1270 ER method, the orifice (diameter x length) is 0.0825 in. by 1.25 in. The test is performed at a temperature of 600° F. using a 1270 g load.

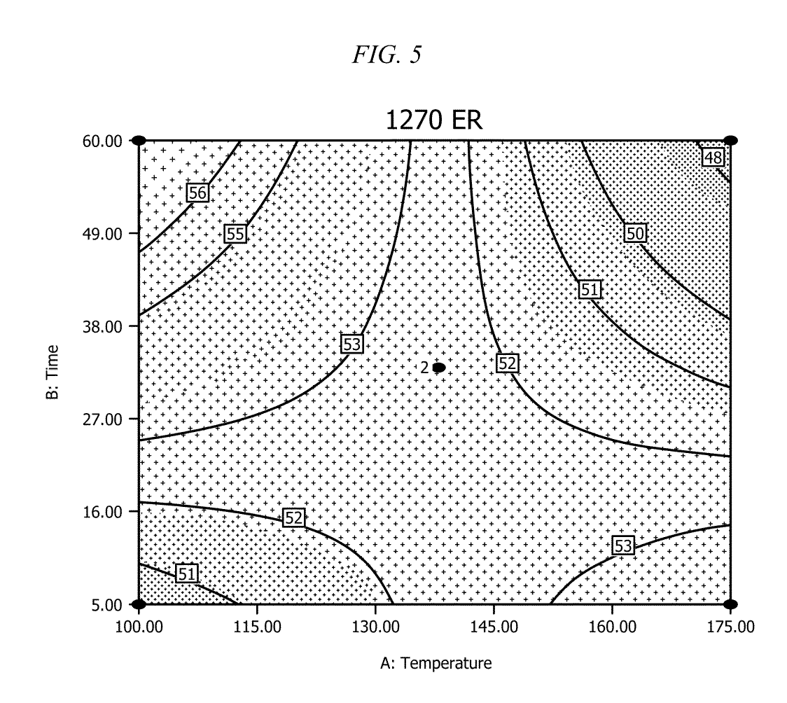

PPS reaction mixture samples were contacted with (e.g., exposed to) DCDPS under various conditions. Upon exposure to the reactive aryl halide, PPS polymer samples were isolated from the PPS reaction mixture, and the PPS polymer samples were washed and dried under normal laboratory conditions to provide washed and dried PPS polymer. Contour diagrams of the effects that temperature and time of exposure have on the 1270 ER of the isolated PPS polymer samples are provided in FIG. 5. The data for the 1270 ER study are displayed in Table 1.

TABLE 1

| Sample # | Temperature [° C.] | Time [min] | 1270 ER [g/10 min] |
|---|---|---|---|
| 1 | 138 | 63 | 53 |
| 2 | 138 | 33 | 57.8 |
| 3 | 175 | 5 | 53.8 |
| 4 | 138 | 33 | 49.4 |
| 5 | 179.5 | 33 | 49.5 |
| 6 | 100 | 5 | 50.7 |
| 7 | 138 | 2 | 52.7 |
| 8 | 175 | 60 | 47 |
| 9 | 95 | 33 | 52.2 |
| 10 | 100 | 60 | 58.1 |
| control | N/A | N/A | 51.6 |

A control sample, in which a PPS reaction mixture sample was washed without exposure to DCDPS, was included for comparison. It is readily apparent from the data displayed in Table 1 that the addition of DCDPS under these conditions had little effect on the flow rate (1270 ER) of the isolated PPS polymer. The variation in the 1270 ER values is within the noise of the measurement.

The most rigorous conditions from this 1270 ER experiment using DCDPS were applied to tests evaluating 1,2,4-TCB (180° C. for 60 minutes) in order to determine whether 1,2,4-TCB can be added when PPS particles were present. An exothermic reaction was noted, suggesting that 1,2,4-TCB was reacting with some material in the PPS reaction mixture. The alcohol extract from this material was analyzed by GC-FID (as previously described) and found to contain no remaining 1,2,4-TCB. To analyze the alcohol extract, the PPS reaction mixture was removed from the reactor and 2 liters of 2-propanol were added. The mixture was stirred for 40 minutes and then filtered to isolate the solid PPS from the mixture. The resulting filtrate was a mixture of NMP, 2-propanol, and reaction soluble materials that were analyzed via GC using the previously described method. Analysis of isolated PPS polymer from this experiment provided a 1270 ER value of 51.3 g/10 min.

It is apparent from these results that it is possible to retard thiophenol formation during processing of the PPS reaction mixture and/or downstream product thereof by using reactive aryl halides. The ability of the reactive aryl halides to react with polymer end groups as well as free thiophenol makes it difficult to identify the underlying mechanism behind reduced thiophenol detection.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### ADDITIONAL DISCLOSURE

A first embodiment, which is a process for producing a poly(arylene sulfide) polymer comprising:

(a) polymerizing reactants in a reaction vessel to produce a poly(arylene sulfide) reaction mixture;

(b) processing at least a portion of the poly(arylene sulfide) reaction mixture to obtain a poly(arylene sulfide) reaction mixture downstream product; and

(c) contacting a reactive aryl halide with at least a portion of the poly(arylene sulfide) reaction mixture and/or downstream product thereof, wherein before and/or after the contacting, the poly(arylene sulfide) reaction mixture and/or downstream product thereof comprise less than about 0.025 wt. % thiophenol, based on the total weight of the poly(arylene sulfide) reaction mixture and/or downstream product thereof.

A second embodiment, which is the process of the first embodiment, wherein a temperature of the poly(arylene sulfide) reaction mixture and/or downstream product thereof is less than about 200° C. prior to (c) contacting with a reactive aryl halide.

A third embodiment, which is the process of any of the first through the second embodiments, wherein the poly(arylene sulfide) reaction mixture is cooled in the reaction vessel to a temperature of less than about 200° C. prior to (c) contacting with a reactive aryl halide, and wherein the reactive aryl halide is added to the reaction vessel.

A fourth embodiment, which is the process of any of the first through the third embodiments, wherein processing the poly(arylene sulfide) reaction mixture comprises washing the at least a portion of the poly(arylene sulfide) reaction mixture with a polar organic compound and/or water to obtain a poly(arylene sulfide) polymer and a first slurry, and wherein the reactive aryl halide is contacted with the first slurry.

A fifth embodiment, which is the process of the fourth embodiment, further comprising evaporating at least a portion of the first slurry comprising the reactive aryl halide to obtain a by-product slurry and one or more vapor fractions.

A sixth embodiment, which is the process of the fifth embodiment, wherein the one or more vapor fractions comprise a recovered polar organic compound.

A seventh embodiment, which is the process of the sixth embodiment, wherein the recovered polar organic compound comprises less than about 0.025 wt. % thiophenol, based on the total weight of the recovered polar organic compound.

An eighth embodiment, which is the process of any of the fifth through the seventh embodiments, wherein the one or more vapor fractions comprise water.

A ninth embodiment, which is the process of any of the fifth through the eighth embodiments, wherein the evaporating is carried out at a temperature of from about 50° C. to about 300° C.

A tenth embodiment, which is the process of any of the fifth through the ninth embodiments, wherein the first slurry comprises poly(arylene sulfide) polymer impurities.

An eleventh embodiment, which is the process of the tenth embodiment, wherein the poly(arylene sulfide) polymer impurities comprise poly(arylene sulfide) polymer fines, poly(arylene sulfide) oligomers, poly(arylene sulfide) low molecular weight polymers, sodium N-methyl-4-aminobutanoate (SMAB), N-4-(chlorophenyl)-N-methyl-4-aminobutanoic acid (SCAB acid), sodium hydroxide (NaOH), sodium acetate (NaOAc), or combinations thereof.

A twelfth embodiment, which is the process of any of the tenth through the eleventh embodiments, wherein the reactive aryl halide reacts with the poly(arylene sulfide) polymer impurities during the evaporating at least a portion of the first slurry, thereby preventing formation and/or accumulation of thiophenol.

A thirteenth embodiment, which is the process of any of the first through the twelfth embodiments, wherein polymerizing reactants further comprises reacting a sulfur source and a dihaloaromatic compound in the presence of a polar organic compound to form the poly(arylene sulfide) polymer.

A fourteenth embodiment, which is the process of any of the first through the thirteenth embodiments, wherein the poly(arylene sulfide) is a poly(phenylene sulfide).

A fifteenth embodiment, which is the process of any of the first through the fourteenth embodiments, wherein the reactive aryl halide is contacted with the poly(arylene sulfide) reaction mixture and/or downstream product thereof in an amount of less than about 2 wt. % reactive aryl halide, based on the total weight of the poly(arylene sulfide) reaction mixture and/or downstream product thereof.

A sixteenth embodiment, which is the process of any of the first through the fifteenth embodiments, wherein the reactive aryl halide comprises a monohalogenated aromatic compound, a polyhalogenated aromatic compound, a dihalogenated aromatic compound, a trihalogenated aromatic compound, a tetrahalogenated aromatic compound, or combinations thereof.

A seventeenth embodiment, which is the process of any of the first through the sixteenth embodiments, wherein the reactive aryl halide comprises monochloro diphenyl sulfone, 4-chlorophenyl phenyl sulfide, 4-chlorobenzophenone, dichloro diphenyl sulfone, 4,4′-dichlorodiphenyl sulfone, dichloro diphenyl sulfide, dichloro diphenyl sulfoxide, dichlorobiphenyl, dibromobiphenyl, p-dibromobenzene, p-diiodobenzene, dichlorobenzonitrile, dichlorobenzoic acid, dichloronaphthalene, dibromonaphthalene, dichlorobenzophenone, trichlorobenzene, 1,2,4-trichlorobenzene, tribromobenzene, trichloronaphthalene, tetrachlorobenzene, tetrachloronaphthalene, or combinations thereof.

An eighteenth embodiment, which is the process of any of the first through the seventeenth embodiments, wherein the reactive aryl halide is characterized by a molecular weight of equal to or greater than about 170 Da.

A nineteenth embodiment, which is the process of any of the first through the eighteenth embodiments, wherein the reactive aryl halide is characterized by a boiling point of equal to or greater than about 210° C.

A twentieth embodiment, which is the process of any of the first through the nineteenth embodiments, wherein the reactive aryl halide is reactive towards a nucleophile present in a poly(arylene sulfide) polymer.

A twenty-first embodiment, which is the process of the twentieth embodiment, wherein the nucleophile comprises a sulfur nucleophile, an oxygen nucleophile, a nitrogen nucleophile, or combinations thereof.

A twenty-second embodiment, which is a process for producing a poly(phenylene sulfide) polymer comprising:

(a) polymerizing reactants in a reaction vessel to produce a poly(phenylene sulfide) reaction mixture;

(b) processing at least a portion of the poly(phenylene sulfide) reaction mixture to obtain a poly(phenylene sulfide) reaction mixture downstream product; and

(c) contacting a reactive aryl halide with at least a portion of the poly(phenylene sulfide) reaction mixture and/or downstream product thereof, wherein before and/or after the contacting, the poly(phenylene sulfide) reaction mixture and/or downstream product thereof comprise less than about 0.025 wt. % thiophenol, based on the total weight of the poly(phenylene sulfide) reaction mixture and/or downstream product thereof.

A twenty-third embodiment, which is a process for producing a poly(arylene sulfide) polymer comprising:

(a) polymerizing reactants in a reaction vessel to produce a poly(arylene sulfide) reaction mixture;

(b) removing at least a portion of the reaction mixture from the reaction vessel to yield a removed portion;

(c) washing the removed portion of the poly(arylene sulfide) reaction mixture with a polar organic compound and/or water to obtain a poly(arylene sulfide) polymer and a first slurry; and

(d) contacting a reactive aryl halide with at least a portion of the first slurry, wherein before and/or after the contacting, the first slurry comprises less than about 0.025 wt. % thiophenol, based on the total weight of the first slurry.

A twenty-fourth embodiment, which is a process for producing a poly(phenylene sulfide) polymer comprising:

(a) reacting a sulfur source and a dihaloaromatic compound in the presence of N-methyl-2-pyrrolidone to form a poly(phenylene sulfide) reaction mixture;

(b) removing at least a portion of the poly(phenylene sulfide) reaction mixture from the reaction vessel to yield a removed portion;

(c) washing the removed portion of the poly(phenylene sulfide) reaction mixture with N-methyl-2-pyrrolidone and/or water to obtain a poly(phenylene sulfide) polymer and a first slurry; and

(d) contacting a reactive aryl halide with at least a portion of the first slurry, wherein before and/or after the contacting, the first slurry comprises less than about 0.025 wt. % thiophenol, based on the total weight of the first slurry.

A twenty-fifth embodiment, which is a process for producing a poly(arylene sulfide) polymer comprising:

(a) polymerizing reactants in a reaction vessel to produce a poly(arylene sulfide) reaction mixture;

(b) cooling the poly(arylene sulfide) reaction mixture in the reaction vessel to a temperature of less than about 200° C.; and

(c) contacting a reactive aryl halide with the poly(arylene sulfide) reaction mixture in the reaction vessel, wherein before and/or after the contacting, the poly(arylene sulfide) reaction mixture comprises less than about 0.025 wt. % thiophenol, based on the total weight of the poly(arylene sulfide) reaction mixture.

A twenty-sixth embodiment, which is a process for producing a poly(phenylene sulfide) polymer comprising:

(a) polymerizing reactants in a reaction vessel to produce a poly(phenylene sulfide) reaction mixture;

(b) cooling the poly(phenylene sulfide) reaction mixture in the reaction vessel to a temperature of less than about 200° C. to yield a cooled poly(phenylene sulfide) reaction mixture; and

(c) contacting a reactive aryl halide with the cooled poly(phenylene sulfide) reaction mixture in the reaction vessel, wherein before and/or after the contacting, the poly(phenylene sulfide) reaction mixture comprises less than about 0.025 wt. % thiophenol, based on the total weight of the poly(phenylene sulfide) reaction mixture.

A twenty-seventh embodiment, which is a process for producing a poly(arylene sulfide) polymer comprising:

(a) polymerizing reactants in a reaction vessel to produce a poly(arylene sulfide) reaction mixture;

(b) removing at least a portion of the reaction mixture from the reaction vessel to yield a removed portion of the reaction mixture;

(c) processing at least a portion of the removed portion of the reaction mixture to obtain a downstream processed product; and

(d) contacting a reactive aryl halide with at least a portion of the (i) poly(arylene sulfide) reaction mixture, (ii) removed portion of the reaction mixture, and/or (iii) downstream processed product, wherein before and/or after the contacting, the (i) poly(arylene sulfide) reaction mixture, (ii) removed portion of the reaction mixture, and/or (iii) downstream processed product comprise less than about 0.025 wt. % thiophenol, based on the total weight of the downstream processed product.

A twenty-eighth embodiment, which is a process for producing a poly(arylene sulfide) polymer comprising:

(a) polymerizing reactants in a reaction vessel to produce a poly(arylene sulfide) reaction mixture;

(b) removing at least a portion of the reaction mixture from the reaction vessel to yield a removed portion of the reaction mixture;

(c) processing at least a portion of the removed portion of the reaction mixture to obtain a solid poly(arylene sulfide) polymer and a liquid product; and

(d) contacting a reactive aryl halide with at least a portion of the (i) poly(arylene sulfide) reaction mixture, (ii) removed portion of the reaction mixture, and/or (iii) liquid product, wherein before and/or after the contacting, the (i) poly(arylene sulfide) reaction mixture, (ii) removed portion of the reaction mixture, and/or (iii) liquid product comprise less than about 0.025 wt. % thiophenol, based on the total weight of the liquid product.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

1. A process for producing a poly(arylene sulfide) polymer comprising:
(a) polymerizing reactants in a reaction vessel to produce a poly(arylene sulfide) reaction mixture;
(b) processing at least a portion of the poly(arylene sulfide) reaction mixture to obtain a poly(arylene sulfide) reaction mixture downstream product; and
(c) contacting a reactive aryl halide with at least a portion of the poly(arylene sulfide) reaction mixture and/or downstream product thereof, wherein before and/or after the contacting, the poly(arylene sulfide) reaction mixture and/or downstream product thereof comprise less than about 0.025 wt. % thiophenol, based on the total weight of the poly(arylene sulfide) reaction mixture and/or downstream product thereof.

2. The process of claim 1, wherein a temperature of the poly(arylene sulfide) reaction mixture and/or downstream product thereof is less than about 200° C. prior to (c) contacting with a reactive aryl halide.

3. The process of claim 1, wherein the poly(arylene sulfide) reaction mixture is cooled in the reaction vessel to a temperature of less than about 200° C. prior to (c) contacting with a reactive aryl halide, and wherein the reactive aryl halide is added to the reaction vessel.

4. The process of claim 1, wherein processing the poly(arylene sulfide) reaction mixture comprises washing the at least a portion of the poly(arylene sulfide) reaction mixture with a polar organic compound and/or water to obtain a poly(arylene sulfide) polymer and a first slurry, and wherein the reactive aryl halide is contacted with the first slurry.

5. The process of claim 4, further comprising evaporating at least a portion of the first slurry comprising the reactive aryl halide to obtain a by-product slurry and one or more vapor fractions.

6. The process of claim 5, wherein the one or more vapor fractions comprise a recovered polar organic compound.

7. The process of claim 6, wherein the recovered polar organic compound comprises less than about 0.025 wt. % thiophenol, based on the total weight of the recovered polar organic compound.

8. The process of claim 5, wherein the evaporating is carried out at a temperature of from about 50° C. to about 300° C.

9. The process of claim 5, wherein the first slurry comprises poly(arylene sulfide) polymer impurities.

10. The process of claim 9, wherein the poly(arylene sulfide) polymer impurities comprise poly(arylene sulfide) polymer fines, poly(arylene sulfide) oligomers, poly(arylene sulfide) low molecular weight polymers, sodium N-methyl-4-aminobutanoate (SMAB), N-4-(chlorophenyl)-N-methyl-4-aminobutanoic acid (SCAB acid), sodium hydroxide (NaOH), sodium acetate (NaOAc), or combinations thereof.

11. The process of claim 9, wherein the reactive aryl halide reacts with the poly(arylene sulfide) polymer impurities during the evaporating at least a portion of the first slurry, thereby preventing formation and/or accumulation of thiophenol.

12. The process of claim 1, wherein polymerizing reactants further comprises reacting a sulfur source and a dihaloaromatic compound in the presence of a polar organic compound to form the poly(arylene sulfide) polymer.

13. The process of claim 1, wherein the poly(arylene sulfide) is a poly(phenylene sulfide).

14. The process of claim 1, wherein the reactive aryl halide is contacted with the poly(arylene sulfide) reaction mixture and/or downstream product thereof in an amount of less than about 2 wt. % reactive aryl halide, based on the total weight of the poly(arylene sulfide) reaction mixture and/or downstream product thereof.

15. The process of claim 1, wherein the reactive aryl halide comprises a monohalogenated aromatic compound, a polyhalogenated aromatic compound, a dihalogenated aromatic compound, a trihalogenated aromatic compound, a tetrahalogenated aromatic compound, or combinations thereof.

16. The process of claim 1, wherein the reactive aryl halide comprises monochloro diphenyl sulfone, 4-chlorophenyl phenyl sulfide, 4-chlorobenzophenone, dichloro diphenyl sulfone, 4,4′-dichlorodiphenyl sulfone, dichloro diphenyl sulfide, dichloro diphenyl sulfoxide, dichlorobiphenyl, dibromobiphenyl, p-dibromobenzene, p-diiodobenzene, dichlorobenzonitrile, dichlorobenzoic acid, dichloronaphthalene, dibromonaphthalene, dichlorobenzophenone, trichlorobenzene, 1,2,4-trichlorobenzene, tribromobenzene, trichloronaphthalene, tetrachlorobenzene, tetrachloronaphthalene, or combinations thereof.

17. The process of claim 1, wherein the reactive aryl halide is characterized by a molecular weight of equal to or greater than about 170 Da.

18. The process of claim 1, wherein the reactive aryl halide is characterized by a boiling point of equal to or greater than about 210° C.

19. The process of claim 1, wherein the reactive aryl halide is reactive towards a nucleophile present in a poly(arylene sulfide) polymer.

20. The process of claim 19, wherein the nucleophile comprises a sulfur nucleophile, an oxygen nucleophile, a nitrogen nucleophile, or combinations thereof.

21. A process for producing a poly(phenylene sulfide) polymer comprising:
(a) polymerizing reactants in a reaction vessel to produce a poly(phenylene sulfide) reaction mixture;
(b) processing at least a portion of the poly(phenylene sulfide) reaction mixture to obtain a poly(phenylene sulfide) reaction mixture downstream product; and
(c) contacting a reactive aryl halide with at least a portion of the poly(phenylene sulfide) reaction mixture and/or downstream product thereof, wherein before and/or after the contacting, the poly(phenylene sulfide) reaction mixture and/or downstream product thereof comprise less than about 0.025 wt. % thiophenol, based on the total weight of the poly(phenylene sulfide) reaction mixture and/or downstream product thereof.

22. A process for producing a poly(arylene sulfide) polymer comprising:
(a) polymerizing reactants in a reaction vessel to produce a poly(arylene sulfide) reaction mixture;
(b) removing at least a portion of the reaction mixture from the reaction vessel to yield a removed portion;
(c) washing the removed portion of the poly(arylene sulfide) reaction mixture with a polar organic compound and/or water to obtain a poly(arylene sulfide) polymer and a first slurry; and
(d) contacting a reactive aryl halide with at least a portion of the first slurry, wherein before and/or after the contacting, the first slurry comprises less than about 0.025 wt. % thiophenol, based on the total weight of the first slurry.

23. The process of claim 1 further comprising treating the poly(arylene sulfide) polymer with an aqueous acid solution, an aqueous metal cation solution, or both.
